(19) United States
(12) Patent Application Publication
(10) Pub. No.: US 2023/0270143 A1
(43) Pub. Date: Aug. 31, 2023

(54) Process And Installation For Producing A Preserved Food Item From A Raw Material. In Particular A Snack Product

(71) Applicant: ELEA SERVICE GMBH, Quakenbrück (DE)

(72) Inventors: Robin Ostermeier, Osnabruck (DE); Stefan Toepfl, Osnabruck (DE); Kevin Hill, Osnabruck (DE)

(21) Appl. No.: 17/924,481

(22) PCT Filed: May 27, 2021
(86) PCT No.: PCT/EP2021/064241

§ 371 Date: Nov. 10, 2022

(30) Foreign Application Priority Data
May 27, 2020 (DE) 10 2020 206 638.8

(51) Int. Cl. A23L 19/18; A23L 19/10; A23B 7/015; A23L 3/32

(52) U.S. Cl. CPC A23L 19/18; A23L 19/105; A23B 7/015; A23L 3/32

(57) ABSTRACT

The present invention relates to a method for producing a preserved food item (1) from a raw material (2), in particular for producing a snack product, comprising the following steps: treating the raw material (2) by applying an electric field; bringing the treated raw material (2) into contact with an aqueous medium (3); and preserving the raw material (2) into a food item (1) after the step of bringing into contact. In order to avoid occurring impurities during the production of preserved food items and to provide a consistent product quality the invention comprises the following method steps: determining a measured value (4) characterizing a product property of the preserved food item (1) and/or an ingredient of the aqueous medium (3); and outputting a control signal (5) as a function of the determined measured value (4). The present invention further related to and installation (6) for producing a preserved food item (1) from a raw material (2), Installation (6) for producing a preserved food item (1) from a raw material (2).

The present invention relates to a method for producing a preserved food item from a raw material, in particular for producing a snack product, including the following steps: treating the raw material by applying an electric field; bringing the treated raw material into contact with an aqueous medium; and preserving the raw material into a food item, after the step of bringing into contact.

The present invention further relates to a preserved food item, particularly a snack product.

Finally, the present invention relates to an installation for producing a preserved food item from a raw material, in particular for producing a snack product, including the following units:
a capacitor for treating the raw product with an electric field;
at least one container for bringing the treated raw material into contact with an aqueous medium; and
a preservation device.

In the production of preserved food items such as snack products, a number of process steps are used to adjust the desired product properties, for example, ingredients, consistency, color, etc. The production of vegetable chips, for example, usually involves washing to remove dirt particles, peeling the raw material if necessary, followed by size reduction. This is followed by a blanching or washing step and deep-frying as a preservation step to remove product moisture, with optional subsequent seasoning and packaging of the products.

In recent years, it has been shown that by treating a raw product with an electric field, the cutting behavior of the raw product may be improved and the product yield increased. It may also lead to lower fat absorption during frying.

However, treatment with an electric field may lead to a higher degree of contamination of the process media used, for example with extracted sugars due to an increased release of intracellular fluids. If the raw material is brought into contact with contaminated process media, for example during transport or washing, contamination may be transferred to the raw material. This may lead to an adverse occurrence of browning reactions during deep-frying or the formation of undesirable substances, which are to be avoided in the interests of product quality that is as consistent as possible.

It is thus the object of the present invention to avoid occurring impurities during the production of preserved food items and to provide a consistent product quality.

This technical problem is solved by the method according to the invention for producing a preserved food item from a raw material, in particular for producing a snack product, by the following steps:
treating the raw material by applying an electric field;
bringing the raw material into contact with an aqueous medium;
preserving the raw product into a food item, after the step of bringing into contact;
determining a measured value characterizing a product property of the preserved food item and/or an ingredient of the aqueous medium; and
outputting a control signal as a function of the determined measured value.

The installation according to the invention for producing a preserved food item from a raw material, in particular for producing a snack product, addresses this object by including the following units:
a capacitor for treating the raw product with an electric field;
at least one container for bringing the raw material into contact with an aqueous medium;
a preservation device;
at least one measuring device for determining a measured value characterizing a product property of the preserved food item and/or an ingredient of the aqueous medium; and
an evaluation unit for outputting a control signal as a function of the determined measured value.

The present object is further solved by a preserved food item, in particular a snack product, produced by the method according to the invention.

By determining a measured value characterizing a product property of the preserved food item and/or an ingredient of the aqueous medium, and by outputting a control signal as a function of the determined measured value, the composition of the process media used and/or of the end product, i.e. the preserved food item, may be controlled and thus effective process monitoring may be ensured. The present invention is based on a detection of the contamination of the process media used or of the essential product properties, and enables an immediate action and optimization of the production by outputting a control signal depending on the detected measured value. For example, certain process parameters may be changed if the determined essential properties of the product do not correspond to the desired properties. Likewise, a control signal may be output to continue the process as is should the desired product properties be achieved when operating the installation or performing the process according to the invention.

Food items are understood to be substances consisting essentially of micronutrients that are consumed to nourish the human body. Macronutrients, i.e. carbohydrates, lipids/fats and proteins supply chemically bound energy to the human body.

Preservation is a process in the treatment of raw materials/food items or food products that makes them last longer by stopping or greatly slowing spoilage, while at the same time either maintaining as much as possible or selectively affecting the nutritional value, taste, color and texture of the food item.

For the purposes of the present invention, a raw food item is to be understood as an unpreserved food item.

A control signal represents a specific instruction for performing the process according to the invention or for operating the installation according to the invention. The control signal may, for example, provide an instruction to change a specific process parameter or to allow the current operation to continue in an unchanged manner.

The invention may be further improved with the following further developments and advantageous embodiments, each of which is advantageous in itself and may be combined with one another as desired.

According to one embodiment, a pulsed electric field may be applied during the treatment of the raw material. Such a pulsed electric field (PEF) may cause cell disruption. Thus, electroporation takes place, in which the semi-permeability of the cell membrane is neutralized by applying an electric field, in particular a pulsed electric field. The neutralization of semi-permeability improves mass transport into the cells and the exchange of intracellular substances, in particular soluble intracellular substances, with the environment. The semi-permeability of the cell membrane may be reversibly or irreversibly neutralized, with irreversible electroporation being preferred if the permanent neutralization of semi-permeability is to provide more flexibility in the sequence of the individual process steps. However, temporary reversible electroporation, which requires less energy than irreversible electroporation, may also be practical.

In the step of treating, the applied electric field may be, in particular, a non-thermal electric field, in which the upper energy limit is such that substantially no heating of the food item occurs in the sense of ohmic heating. In the step of treating with a non-thermal electric field, the raw product may be softened, resulting in an improvement in cutting behavior and increase in product yield due to fewer unclean cut edges.

Upon treatment with an electric field, an energy input of at least 0.1 kJ/kg, preferably from 0.3 to 5.0 kJ/kg may be applied to the raw material. An energy input of this magnitude is well suited to perform irreversible electroporation, depending on the grade- and season-dependent properties of the raw material, thereby improving the cutting behavior and the preservation suitability of the raw material.

It has been shown that it is advantageous if an electric field of 0.1 kV/cm to 10.0 kV/cm, preferably of 0.5 kV/cm to 2.0 kV/cm, is applied. Such field strengths may be achieved with commercially available industrial capacitors and avoid undesirable thermal effects occurring during the treatment of the raw material, which lead to undesirable changes in the chemical composition or structure of the raw material.

The electric field, in particular the electric pulses, may be generated both by direct contact of the capacitor or its electrodes with the raw material, and indirectly via conducting fluids. In the case of indirect treatment, the raw material may be fully or partially immersed in the conductive fluids. Different electrode shapes may be used, for example plate, ring, grid, hollow or flow-through electrodes.

The capacitor may include at least two electrodes connected to a pulse generator. The pulse generator may preferably be a high-voltage pulse generator that generates electric fields in the form of short pulses in the microsecond to millisecond range of a high voltage in the kilovolt range. For example, Marx generators may be used as high-voltage pulse generators.

In terms of time and energy optimization, the raw material may be treated with at least 10 electrical pulses, preferably 10 to 200 electrical pulses and particularly preferably 30 to 50 electrical pulses.

According to a further embodiment, the food item may be produced from a vegetable raw material. The raw material may be, for example, a potato, tuber, root, vegetable or fruit or fruit. The raw commodity may be selected from the group consisting of a tuber vegetable, a root vegetable, a legume vegetable, a pome fruit, a stone fruit, and a shell fruit. According to one embodiment, the raw vegetable may be selected from the group consisting of potatoes, sweet potatoes, pumpkin, parsnip, celery, carrots, cabbage, beet, chickpeas and corn.

According to a further embodiment, a snack product may be produced by the method according to the invention. In this context, snack products are to be understood as preserved food items that constitute a snack, i.e. a snack between meals, which are often offered packaged ready for consumption as finger food. Examples of snack products are snack products such as dried fruits, nut mixtures or savory snacks such as potato chips, vegetable chips, peanut flips or crackers.

According to another embodiment, the raw product may be heated, cooled, frozen, irradiated, dried, vacuumed, and/or gassed during the step of preserving. For example, the raw product may be preserved by cooking. For cooking, the raw product may be thermally heated in a liquid and/or gaseous heat transfer medium, for example water, air, or oil, and converted to an edible state. For example, the raw product may be deep-fried, baked, boiled or hot-air dried for preservation. However, other cooking techniques such as frying or moist cooking techniques such as boiling or steaming are also possible.

According to one embodiment, the raw product may be preserved, i.e. cooked, preferably deep-fried, according to a predetermined temperature-time profile by exposing the raw product to a heat transfer medium of a defined temperature for a fixed period of time. For chips or vegetable chips, for example, deep-frying at 120° C. to 180° C. for a few minutes, for example for up to 15 minutes, preferably for 3 to 9 minutes, has proven to be effective, wherein the shape of the deep-frying curve, i.e. the increase or decrease in the deep-frying temperature over time during deep-frying, may be adapted on the basis of the expected product properties as well as measured values to be determined, for example the product color, the consistency or crispness, the water content, the heat transfer medium content and/or the product shape. Surprisingly, by treating the raw product with an electric field compared to a raw product that has not been exposed to an electric field, a reduction in temperature and/or duration of the preservation step may be achieved.

According to one embodiment, a measured value may be determined that characterizes an ingredient of the aqueous medium released from the raw material, or at least one measuring device may be provided for determining a measured value that characterizes an ingredient of the aqueous medium released from the raw material. For example, a measured value may be determined that characterizes the content of a sugar, a salt and/or a polymer, for example starch, released from the raw material in the aqueous medium.

Alternatively or additionally, a measured value may be determined or a measuring device may be provided that determines a measured value that in turn characterizes a product property of the preserved food item. The product property of the preserved food item may be, for example, the product color, the product consistency, the oil content, the product weight, a spatial extent of the product, e.g. its length, width and/or thickness, or the product moisture.

The measured value may preferably be determined in-line, which enables automation of the process or automated guidance of the installation. The term in-line measurement refers to measurements that are integrated into the manufacturing process (line). The at least one measuring device may be, for example, a sensor or an in-line sensor, which is preferably capable of continuously determining the desired measured values. The sensor may, for example, detect the shape or dimensions of the preserved product, or detect specific properties such as the color, oil content, product moisture or other ingredients of the preserved food item or a specific ingredient of the aqueous medium when the aqueous medium or the preserved product is passed by or comes into contact with the sensor.

The at least one measuring device may be associated with the at least one container for bringing the treated raw product into contact with an aqueous medium or other element including an aqueous process medium used, for determining a measured value characterizing an ingredient of the aqueous medium.

Viable embodiments of a measuring device include optical sensors, electrical sensors, refractometers, turbidimeters, infrared sensors, particle size sensors, or spectrometers.

The container may be part of a washing device. The washing device may include multiple washing tanks or multiple washing chambers within a container to achieve the desired effect, for example, washing out superficially adhering starch, in a single or multi-step washing process. As an alternative to washing in a container, for example, a process may be performed including spraying of the raw material with fresh or process water, for example on a porous belt, and subsequently determining the properties of the process medium.

According to one embodiment, fresh water may be supplied during the step of bringing into contact, wherein the quantity of fresh water supplied depends on the determined measured value. If, for example, the determined measured value, which characterizes a constituent of the aqueous medium released from the raw material, for example a sugar content, starch content or salt content, is outside a predetermined setpoint/setpoint range, the fresh water supply may be increased or throttled. Thus, the amount of fresh water supplied may be optimally adjusted. In this way, the amount of ingredients released from the raw material in the aqueous medium may be controlled, and contamination and the associated risk of transfer of this contamination to the products, as well as any resulting quality disadvantages, may be avoided.

According to a further embodiment, the aqueous medium may be composed of a portion of recycled process water and a portion of fresh water. The proportion of recycled fresh water may depend on the measured value determined. In this way, one not only avoids contamination in the aqueous medium, but at the same time ensures that no unnecessarily high consumption of fresh water occurs. To this end, in one embodiment, the at least one container of the installation according to the invention may have a fresh water supply for introducing fresh water and optionally a process water supply for introducing recycled process water. The supply of the raw material in the aqueous medium is usually carried out in countercurrent to the fresh water supply. However, in a multi-stage configuration, cross-flow guidance is also an option.

According to a further embodiment, the process according to the invention may further include at least one of the following steps:
preparing the raw material by washing and/or peeling, preferably before the step of treating the raw material by applying the electric field;
comminuting and/or shaping the raw material, preferably after the step of treating the raw material by applying an electric field and before the step of bringing it into contact with the aqueous medium;
removing at least a portion of the aqueous medium after the step of bringing into contact with the aqueous medium.

The installation may, according to one embodiment, further include at least one of the following units:
a pretreatment stage for washing the raw material;
a peeling device;
a comminution device;
a dewatering device;
a transport device for moving the raw material within and between the individual units.

The comminution device may include, for example, a shaper, a cutting device, a cutting device with movable blades, or a standing cutting device in a flow channel.

The transport device for moving the raw material may be, for example, a conveyor belt or a screw conveyor. However, the transport device may also be a pump that transports the aqueous medium through the system and transports the raw material together with the aqueous medium.

The dewatering device may include, for example, mechanical, thermal, or combined methods for removing excess process water from the raw product. For example, a vibratory belt, centrifuges, a blower, a hot air blower, a heat radiator, or combinations thereof may be used in the dewatering device.

According to one embodiment, the preservation device may include a drying and/or cooking device. The preservation device may be, for example, a deep fryer. The fryer may be controllably configured to cook the raw product according to a predetermined time-temperature profile.

According to one embodiment, depending on the given control signal, a process parameter may be set in i) treating with an electric field, ii) preserving, iii) bringing into contact with an aqueous medium, and/or iv) comminuting and/or shaping. For this purpose, the installation according to the invention may further include a control unit for setting a process parameter i) of the capacitor, ii) of the preservation device, iii) at the container, of the washing device and/or the transport device, and/or iv) of the comminution device.

In the case of the capacitor and/or the step of treating with an electric field, the treatment intensity, for example the number of pulses, the energy applied, the pulse duration, and/or the treatment duration may be adjusted by the control unit as a function of the output control signal.

In the preservation device and/or the step of preservation, the duration and/or the temperature, for example a predetermined time-temperature profile, may be changed or instructed by the control unit as a function of the determined measured value.

In the case of the container, the washing device and/or the transport device and/or the step of bringing into contact with an aqueous medium, the amount of fresh water, the fresh water supply and/or the fresh water discharge, the duration of the bringing into contact and/or the number of washing steps may be adjusted by the control unit as a function of the determined measured value.

If, for example, an excessively high starch or sugar content is detected in the aqueous medium with a sufficient fresh water supply, a reduction/attenuation of the treatment with an electric field may take place. In this way, it is avoided that the raw material is electroporated too much and that undesirable amounts of ingredients leak out of the raw material into the aqueous medium. If, for example, high starch content is found in the aqueous medium with a comparatively low sugar content, the treatment intensity with an electric field may be increased, for example, to achieve a better cut pattern. An adjustment may also be made to the running time of the comminution device used and, for example, the cutting blades may be sharpened or replaced.

Thus, in the step of comminuting and/or shaping or the comminution device, in one embodiment, a matching with the running time of the knives or a sharpening or replacement of the knives may be performed or initiated by the control unit as a function of the determined measured value/output control signal.

If, for example, a strong browning is detected with the properties of the preserved food otherwise within the normal range, more intensive washing may be implemented, for example, by increasing the supply of fresh water. If other deviations occur at the same time, such as excessive product moisture or excessive oil content in the preserved food, the control unit may implement appropriate measures at the corresponding process stages/installation units. Possible measures include adjusting the frying curve, in particular the frying time and temperature, as well as the temperature curve, i.e. the temperature-time profile within the frying process. In this way, rapid adaptation to changing raw materials and processing properties as well as possible effects of preceding process steps such as cut thickness or surface-to-volume ratio of the comminution steps may be carried out, preferably in-line, i.e. immediately.

An evaluation of the product properties surprisingly showed that after PEF treatment—especially depending on the raw material properties and season—an increase in the slice thickness of the products occurred. Surprisingly, for example, when a slice thickness of 1.3 mm was set for potatoes, an increase in slice thickness up to 1.4 mm occurred after adding PEF treatment. This change apparently causes slower water release and the observed increase in residual product moisture, thereby necessitating adjustments to the process line. The present invention allows, on the basis of determination of product properties such as product moisture, in particular when this is determined in-line, immediate adjustment of process conditions at different stages of the manufacturing process of a snack product, e.g. potato chips.

According to a further embodiment, when an increase in product moisture is detected, a control signal may be output, depending on which one or more of the following process parameters is adjusted: (i) adjustment of a comminution parameter, for example, the cutting thickness, e.g., by adjusting the blade distance or by changing the cutting force or the rotation speed of the cutting head; (ii) adjustment of the intensity of the PEF treatment (resulting in, for example, the reduction of the surprising influence of the PEF treatment on the cut thickness of the product as described above); (iii) adjustments of the preservation conditions, for example, the frying conditions, e.g., by increasing the frying temperature, preferably in the first frying stage or at the beginning of the frying, if necessary, while reducing the temperature in the last frying stage or the frying time. If reduced product moisture is determined, a control signal may be output that sets the corresponding process parameter in the opposite direction.

According to a further embodiment, if an increased fat content of the product is determined, a control signal may be output depending on which one or more of the following process parameters is adjusted: (i) increasing the intensity of the PEF treatment to improve the cut appearance, (ii) shortening the frying time. If a reduced fat content of the product is determined, a control signal may be output to adjust the corresponding process parameter in the opposite direction.

According to a further embodiment, if an increased browning of the product is detected, a control signal may be output, depending on which one or more of the following process parameters is adjusted: (i) adjustment of the PEF intensity, for example, by increasing the energy input up to a value, at which a maximum reduction of the cutting force is achieved; (ii) adjustment of the washing step, for example, increasing the exposure time and/or temperature or adding a higher proportion of fresh water or adding a wash step. (iii) adjustment of the preservation conditions, e.g. the frying conditions, e.g. reduction of the frying temperature in a final frying step or at the end of the frying process, if necessary by increasing the frying temperature in the first frying step and adjusting the frying time. If a reduced browning of the product is determined, a control signal may be output that adjusts the corresponding process parameter in the opposite direction.

According to a further embodiment, the determined measured value may be compared with a predetermined setpoint value or setpoint value range and a control signal for changing a process parameter may be output if the difference between the determined measured value and the predetermined setpoint value exceeds a limit value (or threshold value) or the determined measured value is outside the setpoint value range. The predetermined setpoint value may be stored in the evaluation unit, which may be connected to the at least one measuring device in a signal-transmitting manner. The setpoint value may further be an empirical value or predetermined based on artificial intelligence, an algorithm, a pre-programmed or learned algorithm.

This allows a knowledge- and experience-based optimization of the production of preserved food items, for example snack products, based on the acquisition of measured values. This results in an optimized process both in terms of the product properties achieved and in terms of process quality. In this way, a preserved food item of consistently high quality may be produced and an unnecessarily high consumption of resources, for example fresh water or energy, may be avoided. The present invention permits rapid adjustment of the process conditions and, by recording the effects of the measures introduced and feeding them back to the process or installation, rapid, controlled adjustment and guidance of the manufacturing process to different raw material properties.

According to a further embodiment, the determined measured values and the output control signals may be stored and optionally evaluated. For example, the temporal course of the determined measured values and the control signals output as a function thereof, i.e. the changes in the process control, may be documented in order to optimize the process control. Here, it may be appropriate to use self-learning algorithms based on artificial intelligence.

The evaluation unit may, in one embodiment, include a memory unit for recording the measured values and/or the control signals. The evaluation unit may additionally or alternatively include a computing unit for analyzing the measured values and/or an algorithm, for example a pre-programmed or self-learning algorithm, for converting a measured value into a control signal. Thus, measures may be suggested by the evaluation unit on the basis of programmed or learned algorithms and implemented at the corresponding units or in the corresponding process stages to enable rapid adaptation to changing raw material and processing properties.

In the following, the invention is explained in more detail by means of advantageous embodiments with reference to the drawings by way of example. The advantageous further developments and embodiments shown thereby are in each case independent of one another and may be combined with one another as desired, depending on the requirements of the application.

In the Figures:

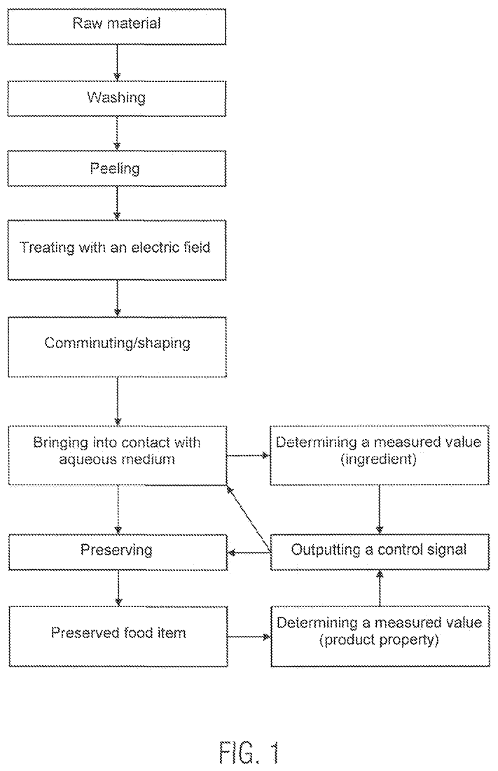

FIG. 1. is a flowchart of a sequence for an exemplary process according to one embodiment of the present invention: and

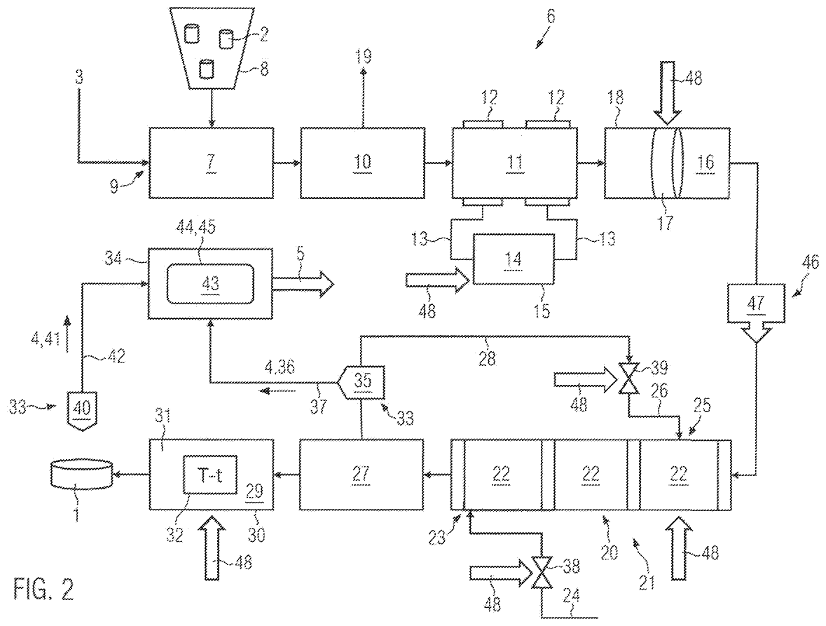

FIG. 2. is a schematic diagram of an embodiment of an installation according to the present invention for producing a preserved food item from a raw material.

In the following, an exemplary process for producing a preserved food item from a raw material, for example for producing a snack product, is presented with reference to the flow diagram of FIG. 1, before an exemplary embodiment of an installation for producing a preserved food item is presented with reference to FIG. 2, on which the process according to the invention may be carried out.

The process for producing a preserved food item 1 from a raw material 2, in particular for producing a snack product, includes the following steps:
treating the raw material 2 by applying an electric field;
bringing the treated raw material 2 into contact with an aqueous medium 3;
preserving the raw material 2 into a food item 1, after the step of bringing into contact;
determining a measured value 4 characterizing a product property of the preserved food item 1 and/or an ingredient of the aqueous medium 3; and
outputting a control signal 5 in response to or as a function of the determined measured value 4.

In the exemplary flowchart of FIG. 1, the step of treating the raw material 2 by applying an electric field takes place after the raw material, for example, a raw vegetable product such as a tuber, a root, or a fruit such as a sweet potato, is first washed to remove dirt particles and then peeled. In the step of treating with an electric field, the raw material 2 may be exposed to a pulsed electric field (PEF), which causes cell disruption, thereby neutralizing or removing semi-permeability of the cell membrane. Through the use of a pulsed electric field, tissue softening may be achieved and turgor pressure within the cells is reduced, partially releasing intracellular components.

Following electroporation, in the exemplary process according to the flowchart of FIG. 1, the food is comminuted, namely cut, and brought into shape.

This is followed by the step of bringing into contact with an aqueous medium 3, which may be a washing step, in which aqueous medium 3 is added to the cut raw material 2. A transport step in an aqueous medium 3 is also possible, i.e. the raw material 2 is moved through the aqueous medium 3 within and between the individual process steps.

Finally, the step of preserving the raw material 2 into a preserved food item 1, for example sweet potato chips or another snack product, such as a savory snack, potato chips, peanut flips, takes place. For this purpose, the food item may be cooked, for example deep-fried.

In the flowchart of FIG. 1, according to the invention a measured value 4 is determined that characterizes a product property of the preserved food item 1. This may be, for example, the product color (e.g., the browning of the product), the product shape (e.g., the cut thickness), the product consistency or the product moisture or oil content of the product. In the exemplary method according to the flowchart of FIG. 1, a measured value 4 is further determined that characterizes an ingredient, an ingredient of the aqueous medium 4 released from the raw material 2. The ingredient may be, for example, the content of a sugar, a polymer or salt, for example the content of free starch.

Depending on the determined measured values, a control signal is finally output according to experience. Depending on the control signal output, a process parameter may be changed, for example in the step of treating with an electric field (e.g., the treatment intensity), in the step of preserving (e.g., the duration or temperature of the preservation step), in the step of bringing into contact with an aqueous medium 4 (e.g., the residence time in the aqueous medium 4, e.g., the residence time in the aqueous medium, the number of treatment steps, or the composition of the aqueous medium 4), and/or in the step of comminuting (e.g., the instruction for sharpening or replacing the cutting device, or the spacing of the knives). In the flowchart of FIG. 1, according to the invention a control signal is output to the step of bringing into contact with an aqueous medium and/or the step of preserving. The control signal as feedback may adjust the process parameters of these steps as a function of the determined measured value, in order to obtain the desired product properties or to allow the process to run efficiently (e.g. with regard to resources such as energy and/or fresh water requirements). Therefore, performing the process enables closed control loops to be used.

In the following, an exemplary installation 6 for producing a preserved food item 1 from a raw material 2 is presented with reference to the schematic representation of FIG. 2. In the context of this presentation, the exemplary process according to the flowchart of FIG. 1, which may be carried out using the installation according to the invention, for example the exemplary installation 6 of FIG. 2, will be explained in more detail.

The installation 6 shown in FIG. 2 includes a pretreatment stage 7 for washing the raw material 2. Associated with the pretreatment stage 7 is a supply 8 for feeding the raw material 2 and an inlet 9 for feeding an aqueous medium 4 as the washing medium of the pretreatment stage 7.

From the pretreatment stage 7, the washed raw material 2 is transferred to a peeling device 10, where the peel 19 is removed.

The installation 6 shown in FIG. 2 further includes a capacitor 11 for treating the raw material 2, in the embodiment shown the peeled raw material, with an electric field, here for example a pulsed electric field. The capacitor 11 (hereinafter also referred to as electroporator) includes at least two electrodes 12 forming the capacitor 11 for generating an electric field. The electrodes 12 of the capacitor 11 are connected to a voltage source 14 via energy lines 13. In the embodiment shown, the two electrodes 12 are arranged collinearly. For this purpose, two ring- or tube-shaped electrodes 12 are arranged at a distance from each other along a transport direction T, along which the peeled raw material 2 is moved through the electroporator 11. The electrodes 12 of the capacitor 11 may also be arranged on opposite sides and parallel to each other. With such a parallel electrode arrangement, a homogeneous electric field may be generated for uniform treatment of the peeled raw material 2. Other variants, such as a coaxial or conical electrode arrangement, are also conceivable.

A pulse generator 15, such as a Marx generator, may be used as voltage source 14, with which electrical high-voltage pulses of a high voltage in the kV range and a short duration in the micro to millisecond range may be generated. The electrodes 12 may be made of stainless steel or a titanium alloy, for example.

The electroporated raw material 2, i.e., the raw material treated in an electric field, is then comminuted and/or shaped into the desired form in a comminution device 16 of the installation 6. In the exemplary embodiment, the comminution device 16 includes a cutting device 17. In the present case, it is a standing cutting device 17 arranged in a flow channel 18, wherein the electroporated raw material 2 is transported in an aqueous medium 4 through the standing cutting device 17 and is comminuted in the process. Alternatively, movable knives or other comminution devices may be used depending on the type of raw material 2 to be treated and the desired preserved food item.

The cut raw material 2 is then brought into contact with an aqueous medium 4 in at least one container 20. The container 20 may be a washing device 21 or a transport device 46, in which the raw material 2 treated with an electric field and subsequently cut is transported to the further units of the installation.

The transport device 46 for moving the raw material 2 may be, for example, a conveyor belt or a screw conveyor (not shown). The transport device 46 may also be, as in the exemplary embodiment of FIG. 2, a pump 47, which transports the aqueous medium 4 through the installation 6 and transports the raw material 2 together with the aqueous medium 4.

In the embodiment shown in FIG. 2, the container 20 is part of a washing device 21. The washing device 21 includes a plurality of washing chambers 22, in which a multi-stage washing process or process step of bringing the treated raw material 2 into contact with an aqueous medium may be carried out. It is equally possible to provide the washing device 21 with a plurality of washing tanks or other contact segments (not shown).

The raw material 2 treated with an electric field and cut is fed at one end of the washing device 21. At this end, the container 2 also contains a process water supply 25 for introducing recycled process water 26. At the other end of the washing device 22, a fresh water supply 23 is provided for introducing fresh water 24 is provided in the installation 6 shown. The aqueous medium 4, with which the raw material 2 is brought into contact in the container 20, is thus composed of a portion of fresh water 23 and a portion of recycled process water 26. In the exemplary embodiment shown, fresh water 24 and recycled process water 26 are guided in countercurrent flow. It is also possible to guide them in cross-flow, which may be advantageous, for example, in a multi-stage configuration.

The further washing chambers 22 of the washing device 21 of FIG. 2 are merely indicated schematically. Each of these washing chambers 22 may be provided with a separate fresh water supply 23 or process water supply 25, but this is not shown in FIG. 2 for the sake of clarity.

The recycled process water 26 may originate from a dewatering device 27, in which excess aqueous medium 4 may be removed from the raw material 2, for example, by mechanical, thermal or combined processes, such as a vibrating belt, centrifuges, hot air treatment or other devices, as well as combinations thereof.

In the exemplary embodiment shown, a return line 28 is provided, in which the process water 26 removed in the dewatering device 27 is returned from the dewatering device to the container 20. The returned process water 26 may alternatively originate from any other unit of the installation 6, for example the pretreatment stage 7 or the cutting device 17, in which process water 26 is removed from the installation 6.

The dewatering device 27 is followed by a preservation device 29, in which the raw material 2 is preserved into a food item 1. The preservation device 29 may be a cooking device 30, for example a deep fryer. In the preservation device 28, the raw material 2 is brought into contact with a liquid or gaseous heat transfer medium 31, such as water, oil or air. In the embodiment shown, the step of preserving is performed according to a predetermined temperature-time profile 32 such that the residence time of the raw material 2 in the preservation device 29 and defined temperature levels, for example 140° C. to 180° C., are determined to achieve the desired product properties of the preserved raw material 1.

In order to achieve the desired product properties of the preserved raw material 2 and to allow the process to run as far as possible under optimum process conditions, at least one measuring device 33 for determining a measured value 4 and an evaluation unit 34 for outputting a control signal 5 as a function of the determined measured value 4 are provided in the installation 6 according to the invention.

The installation 6 shown in FIG. 2 includes a measuring device 35 for determining a measured value 36 that characterizes a constituent of the aqueous medium 3. The measured value 36 in the embodiment shown is an ingredient of the aqueous medium 3 released from the raw material 2. The ingredient may be, for example, a sugar, a salt, or a polymer, for example starch, that escapes from the raw material 2 during contact of the treated raw material 2 with the aqueous medium 3 and is transferred into the aqueous medium 3.

The measuring device 35 is connected to the evaluation device 34 in a data-transmitting manner. When the present application refers to “connected in a data-transmitting manner”, this includes both wired and wireless transmission of the measured values 4 from the measuring device 33 to the evaluation device 34, for example via lines or by means of radio technology.

In the embodiment of the installation shown, the measuring device 35 is connected to the evaluation device 34 by a measuring line 37, via which the measured value 36 is transmitted from the measuring device 35 to the evaluation device 34. Of course, the measuring line 37 may be omitted if the measured value transmission between the measuring device 35 and the evaluation device 34 is wireless, for example via a radio link.

It applies to all lines presented in the context of the present invention that they may be of both cabled and wireless design, and that signals or data may be transmitted via these lines not only in the direction indicated by arrows, but also in the opposite direction.

In the exemplary installation 6 of FIG. 2, the evaluation device 34 may output a control signal 5 as a function of the determined measured value 3. For example, the measuring device 35 may be used to determine in-line the composition of the aqueous medium 4 by, for example, optical or electrical measurement methods such as refractometry, turbidity measurement, particle size analysis or infrared measurement in order to determine, for example, the content of sugar, starch, salt and other ingredients released from the raw material 2. For this purpose, the measuring device 35 is assigned to the return line 28. However, the measuring device 35 may likewise be assigned to the container 20, for example to one of its washing chambers 22.

The control signal 5 output by the evaluation unit 34 is transmitted to a control unit 48. The control unit 48 (symbolized by an arrow) may, for example, be assigned to an inlet valve 38 of the fresh water supply 23. In this way, fresh water 24 may be supplied during the step of bringing into contact, whereby the quantity of fresh water supplied may depend on the measured value 36 determined.

The control signal 5 may additionally or alternatively be output to a control unit 48 of a return valve 39, which adjusts the amount of process water 35 returned through the return line 28. Thus, the aqueous medium 3 may be composed of a portion of recycled process water 26 and a portion of fresh water 24. In this way, it is possible to avoid excessive contamination of the aqueous medium 4 and undesirable transfer of the contamination to the preserved food items 1, as well as any resulting quality defects. At the same time, it may be ensured that no unnecessarily high consumption of fresh water 24 occurs.

The control signal 5 may also be output by the evaluation device 34 to a control unit 48 of the capacitor 11. If, for example, a high starch and sugar content is simultaneously detected in the aqueous medium 3 while the fresh water supply is already sufficient, a reduction in electroporation may be carried out.

The evaluation device 34 may also output a control signal 5 to a control unit 48 of the cutting device 17. If, for example, a high starch content is detected in the aqueous medium with a comparatively low sugar content, an increase in the treatment intensity of the electroporator 11 may first be initiated by outputting the control signal 5 to a control unit 48 of the electroporator 11. At the same time, a comparison may be made with the running time of the cutting devices 17 used in the comminution device 16 and, for example, sharpening or replacement of the cutting devices 17 may be carried out.

In the embodiment shown, there is provided a further measuring device 33, a measuring device 40 for determining a measured value 41 characterizing a product property of the preserved food item 1. The measuring device 40 may determine, for example by means of infrared spectroscopy, essential properties of the preserved food item 1, for example product color, oil content or also product moisture, and output a corresponding measured value to the evaluation device 34 via a further measuring line 42.

Depending on the measured value 41, the evaluation device 34 outputs a control signal 5, for example to the control unit 48 of the electroporator 11, in order to adjust the treatment intensity, or to the control unit 48 of the inlet valve 40 or the return valve 39 or the control unit 48 of the container 20 to achieve a reduction or increase in the fresh water supply or process water recycling. The control signal 5 may also be output to the control unit 48 of the preservation device 29, for example to cause a reduction or increase in the preservation intensity, for example adjustment of the temperature-time profile 32.

For example, if heavy browning of the preserved food item 1 is detected, more intensive washing may be implemented by increasing the supply of fresh water, the duration of washing or the temperature of the washing medium. Alternatively or additionally, the intensity of the electric field treatment may be adjusted, for example by increasing the energy input, up to a value, at which a maximum reduction of the cutting force is achieved. The preservation conditions may also be adjusted, e.g. by reducing the frying temperature in the last frying stage or at the end of the frying process, or by increasing the frying temperature in the first frying stage and adjusting the frying time. If other deviations occur alternatively or simultaneously, such as excessive product moisture or excessive fat/oil content, a control signal 5 may be output by the evaluation device 34 on the basis of predetermined setpoints 43 and implemented at the corresponding process stages.

For example, in the evaluation device 34 the determined measured value 4, 36, 41 may be compared with a predetermined setpoint 43 and a control signal 5 for changing a process parameter may be output if the difference between the determined measured value 4, 36, 41 and the predetermined setpoint 43 exceeds a limit value. The limit value reflects a tolerance range around a predetermined target parameter, wherein the difference takes into account both the deviation above and below the target parameter and may thus cover both under-treatment and over-treatment.

The predetermined setpoint 43 may be an empirical value, as well as a learned empirical value, an algorithm, for example a pre-programmed or learned algorithm. For example, an artificial intelligence may be implemented in the evaluation unit 34, which continuously monitors and self-learningly optimizes the measures taken and control signals 5 output in order to regulate a product property of the preserved food item or an ingredient of the aqueous medium 4.

The evaluation device 34 may include, for example, a memory unit 44 for recording the transmitted measured values 4, 36, 41 and/or the output control signals 5. The evaluation device 34 may also include a computing unit 45 for analyzing the measured values 4, 36, 41. In this context, the computing unit 45 may, for example, access a setpoint algorithm 43 for converting a measured value 4 into a control signal 5.

The memory unit 44, which may also be called a logging unit, may record all measured values 4 and output control signals 5 as well as other operating parameters of the installation 6. For example, the supplied fresh water 24, the recycled process water 26, the treatment intensity of the electroporator 11, the running time of the cutting device 17, the applied temperature-time profile 32, the number of washing chambers 22, etc. may be recorded. The logging unit allows documentation of the process control of the installation 6 according to the invention and allows conclusions to be drawn about the effectiveness of the controls made by the control signals 5 that were output, so that the installation 6 may be optimized in a self-learning manner.

The process according to the invention and the installation according to the invention thus permit a knowledge- and experience-based optimization of the production of a preserved food item 1, for example a snack product, based on an in-line acquisition of measured variables and results in a process that is optimal with respect to the properties of the preserved food item 1 and to the process quality. In this way, a high-quality food item 1 may be produced and an unnecessarily high consumption of fresh water 24 and energy may be avoided. In-line data acquisition and evaluation allows fast adjustment of the process conditions and, by detection and influence of the measures introduced and their feedback, also allows rapid, controlled adjustment of the process to different raw material properties.

In a series of experiments, whole potatoes were subjected to PEF treatment with an energy input of 0.2 to 0.8 kJ/kg. The potatoes were then sliced using a slicer. After a washing step, the potato slices were deep-fried in a continuous frying line in several frying stages and further processed into chips. After PEF treatment, it was found that the product moisture of the final product increased compared to untreated potatoes (which were not treated with PEF with all other process step settings remaining the same). Surprisingly, an increase in the moisture content of the final product, i.e. potato chips, from 2.0 to 2.2% was observed. To compensate for this unexpected influence, for example, an adjustment of the frying conditions may be made based on the product properties determined on the final product. For example, the frying temperature may be increased to reduce the moisture content and restore it to the desired setpoint. The tests also showed that increasing the temperature in a first frying stage is particularly effective. Surprisingly, it was found that this does not lead to an increase in the proportion of heavily browned products after PEF treatment, as is usually the case.

Further evaluation of the product properties of these trials showed that, depending on the raw material properties and season, an increase in the slice thickness of the products is observed after PEF treatment. Surprisingly, for example, when a slice thickness of 1.3 mm was set for potatoes, an increase in slice thickness up to 1.4 mm occurred after adding PEF treatment. This change apparently causes a slower release of water and an increase in the residual moisture of the product was determined. The higher residual moisture thus necessitates adjustments to the process line, which may be made as described above. The procedure according to the invention thus allows, on the basis of the in-line determination of the product properties, such as the product moisture, an adaptation of the process conditions at different stages of the manufacturing process of potato chips.

### REFERENCE NUMERALS

1 preserved food item
2 raw material
3 aqueous medium
4 measured value
5 control signal
6 installation
7 pretreatment stage
K supply of raw material
9 inlet of an aqueous medium
10 peeling device
11 capacitor/electroporator
12 electrodes
13 energy line
14 voltage source
15 pulse generator
16 comminution device
17 cutting device
18 flow channel
19 peel
20 container
21 washing device
22 washing chamber
23 fresh water supply
24 fresh water
25 process water supply
26 process water
27 dewatering device
28 return line
29 preservation device
30 cooking device
31 heat transfer medium
32 temperature-time profile
33 measuring device
34 evaluation device
35 measuring device of the aqueous medium
36 measured value of the aqueous medium
37 measuring line
38 supply valve
39 return valve
40 measuring device of the preserved food
41 measured value of the preserved food
42 measuring line
43 setpoint
44 memory unit
45 computing unit
46 transport device
47 pump
48 control unit
T transport direction

1. Method for producing a preserved food item (1) from a raw material (2), in particular for producing a snack product, comprising the following steps:
treating the raw material (2) by applying an electric field;
bringing the treated raw material (2) into contact with an aqueous medium (3);
preserving the raw material (2) into a food item (1) after the step of bringing into contact;
determining a measured value (4) characterizing a product property of the preserved food item (1) and/or an ingredient of the aqueous medium (3); and
outputting a control signal (5) as a function of the determined measured value (4).

2. Method according to claim 1, wherein a pulsed electric field is applied when treating the raw material (2).

3. Method according to claim 1, characterized in that a measured value (4) is determined that characterizes the content of a sugar, a salt and/or a polymer in the aqueous medium (3).

4. Method according to claim 1, characterized in that fresh water (24) is supplied in the step of bringing into contact, wherein the quantity of fresh water supplied is a function of the measured value (4) determined.

5. Method according to claim 4, characterized in that the aqueous medium (3) is composed of a portion of recycled process water (26) and a portion of fresh water (24).

6. Method according to claim 1, further comprising at least one of the following steps:
preparing the raw material (2) by washing and/or peeling, preferably before the step of treating the raw material (2) by applying an electric field;
comminuting and/or shaping the raw material (2), preferably after the step of treating the raw material (2) by applying an electric field and before the step of bringing it into contact with the aqueous medium (3);
removing at least part of the aqueous medium (3) after the step of bringing into contact with the aqueous medium (3).

7. Method according to claim 1, characterized in that, as a function of the control signal (5) output, a process parameter is set during i) treatment with an electric field, ii) preservation, iii) bringing into contact with an aqueous medium (3) and/or iv) comminution and/or shaping.

8. Method according to claim 1, characterized in that the determined measured value (4) is compared with a predetermined setpoint value (43), and a control signal (5) for changing a process parameter is output if the difference between the determined measured value (4) and the predetermined setpoint value (43) exceeds a limit value.

9. Method according to claim 1, characterized in that the determined measured values (4) and the output control signals (5) are stored and optionally evaluated.

10. Method according to claim 1, characterized in that the food item (1) is produced from a vegetable raw material (2).

11. Preserved food item (1), in particular snack product, produced according to the method according to claim 1.

12. Installation (6) for producing a preserved food item (1) from a raw material (2), in particular for producing a snack product, comprising the following units:
a capacitor (11) for treating the raw material (2) with an electric field;
at least one container (20) for bringing the treated raw material (2) into contact with an aqueous medium (3);
a preservation device (29);
at least one measuring device (33) for determining a measured value (4) that characterizes a product property of the preserved food item (1) and/or an ingredient of the aqueous medium (4); and
an evaluation device (34) for outputting a control signal (5) as a function of the determined measured value (4).

13. Installation (6) according to claim 12, further comprising at least one of the following units:
a pretreatment stage (7) for washing the raw material (2);
a peeling device (10);
a comminution device (16);
a dewatering device (27);
a transport device (46) for moving the raw material (2) within and between the individual units.

14. Installation (6) according to claim 12, further comprising a control unit (48) configured for adjusting a process parameter of i) the capacitor (11), ii) the preservation device (29), iii) at the container (20) and/or iv) the comminution device (16).

15. Installation (6) according to claim 12, characterized in that the at least one container (20) comprises a fresh water supply (23) for introducing fresh water (24) and optionally a process water supply (25) for introducing recycled process water (26).

16. Method according to claim 2, characterized in that a measured value (4) is determined that characterizes the content of a sugar, a salt and/or a polymer in the aqueous medium (3).

17. Method according to claim 2, characterized in that fresh water (24) is supplied in the step of bringing into contact, wherein the quantity of fresh water supplied is a function of the measured value (4) determined.

18. Method according to claim 2, further comprising at least one of the following steps:
preparing the raw material (2) by washing and/or peeling, preferably before the step of treating the raw material (2) by applying an electric field;
comminuting and/or shaping the raw material (2), preferably after the step of treating the raw material (2) by applying an electric field and before the step of bringing it into contact with the aqueous medium (3);
removing at least part of the aqueous medium (3) after the step of bringing into contact with the aqueous medium (3).

19. Installation (6) according to claim 13, further comprising a control unit (48) configured for adjusting a process parameter of i) the capacitor (11), ii) the preservation device (29), iii) at the container (20) and/or iv) the comminution device (16).

20. Installation (6) according to claim 13, characterized in that the at least one container (20) comprises a fresh water supply (23) for introducing fresh water (24) and optionally a process water supply (25) for introducing recycled process water (26).
